(19) United States
(12) Patent Application Publication
(10) Pub. No.: US 2017/0329502 A1
(43) Pub. Date: Nov. 16, 2017

(54) METHOD AND DEVICE FOR PROCESSING IMAGE

(71) Applicants: Teh-Ming WU, Taipei (CN); MARKETING MANUFACTURING & TECHNOLOGY (SHANGHAI) CO., LTD., Shanghai (CN)

(72) Inventor: Teh-Ming WU, Taipei (CN)

(73) Assignees: Teh-Ming WU, Taipei (CN); MARKETING MANUFACTURING & TECHNOLOGY (SHANGHAI) CO., LTD., Shanghai (CN)

(21) Appl. No.: 15/522,302

(22) PCT Filed: Dec. 28, 2015
(86) PCT No.: PCT/CN2015/099257

§ 371 Date: Apr. 27, 2017

(30) Foreign Application Priority Data
Oct. 27, 2014 (CN) 201410581789.4

(51) Int. Cl. G06F 3/0484; H04N 1/393; G06F 17/30; G06T 11/00; G06T 1/00

(52) U.S. Cl. CPC G06F 3/04845; H04N 1/3935; G06F 17/30244; G06T 1/0007; G06T 11/001

(57) ABSTRACT

The present invention provides a method and device for image processing. A user device performs the image processing based on the first template elements selected by a user, and sends the image processing information about the image processing to the corresponding network device, such that the network device performs the image processing based on the image processing information by invoking the second template element, thereby obtaining a second image. Thus, the image processing overhead of the user device is reduced and the traffic is saved for the user with improved user experience of image processing.

### CROSS REFERENCE TO RELATED APPLICATIONS

This application is the national phase entry of International Application No. PCT/CN2015/099257, filed on Dec. 28, 2015, which is based upon and claims priority to Chinese Patent Application No. 201410581789.4, filed our Oct. 27, 2014, the entire contents of which are incorporated herein by reference.

### TECHNICAL FIELD

The present invention relates to the field of computers, and in particular, to a technique for image processing.

### BACKGROUND OF THE INVENTION

At present, processing, such as image design and the like, is generally achieved simply by means of image processing software. However, some image processing software only supports processing and design of bitmap images, which are prone to distortions, such as blurring, variation and the like, during processing; or, even though the image processing software can convert bitmap images into vectors having higher resolution, there will be massive calculation. In particular, for such processing as image design on a mobile device, the existing mode of such processing as image design may influence the flexibility and efficiency of image processing by a user, consume more traffic and also impact the user experience of image processing the due to limited processing resources and bandwidth resources of the mobile device.

Analysis is now made on the prior art as below.

1) With regard to the patent No. US20140126841(A1) (WANG Ching-Wei, HUNG Chu-Mei, Taipei, 2014) entitled “The Real-time cloud image system and managing method thereof”, this invention presents a real-time cloud image system that includes at least a frontend device and a backend system. The backend system may provide different tiles in a region of interest of a raw image or an image other than the raw material to the frontend device according to the instruction, information and ROI (region of interest) information generated in the frontend device. While the present invention mentions the frontend and backend devices, the real-time cloud image system is intended for image management, where image layers of various resolutions are stored in its backend system with regard to the same image for invoking by the frontend device.

2) With regard to patent No. US 20140153808 (Junnan Wu, Robert James Taylor, 2014) entitled “Cloud-based medical image processing system with tracking capability”, this invention provides a cloud-based medical image processing system with tracking capability, where a cloud server receives a request for accessing medical image data from a client device; the medical image data of a user is determined and tracked on the cloud server, and then stored; next, an analysis is performed on the tracked information of the user to determine an overall usage trend of the image views. This invention involves sending an image processing request by means of the software of the client device and the image processing is carried out on the cloud server over a network. However, this invention is intended for medical image tracking, and the image tracking requests are all sent by clients on PCs.

3) With regard to the patent No. WO2013123085A1 (Tiecheng Zhao, Robert James Taylor) entitled “Cloud-based Medical Image Processing System with Anonymous Data Upload and Download”, this invention relates to a cloud-based medical image processing system with data upload and download, where a local device receives a 3D medical image captured by a medical imaging device, and 3D medical image data is obtained by removing certain metadata, and then the 3D medical image is automatically uploaded to a cloud server over a network. When a signal is received from the cloud server indicating that there is an updated 3D medical image available at the cloud server, the updated 3D medical image is automatically downloaded from the cloud server at the local device, and then stored. This invention is intended for medical image access, including upload and download of images. Just like the invention 2), the requests for medical images are all sent from PCs.

4) With regard to the patent entitled “Personal Cloud Computing With Session Migration” (Lianwen Jin, Dapeng Tao, 2012), this invention provides a cloud computing mobile phone image annotation method, where personal digital images are managed by image annotations with no design processing thereon. Due to the problems of limited computing resources and small storage capacity of a mobile terminal, this invention presents computing by means of cloud, and the compressed images from the mobile terminal may be decoded on the cloud.

5) With regard to the Patent No. U.S. Pat. No. 8,693,993 (Microsoft. Corporation, 2008) entitled “Personalized cloud of mobile tasks”, this invention provides a method of helping personalizing a mobile device by means of cloud computing, where a personalized cloud generator is used for searching for a task, and a corresponding icon may be generated in the display screen of a mobile device according to the number of times of access or use so that the user can access the task that has been accessed before quickly and easily thereafter. In this invention, personalization is achieved by creating icons with regard to tasks such as URL access or software used on the personal mobile device.

6) With regard to the patent No. U.S. Pat. No. 8,725,800B1 entitled “Mobile photo application migration to cloud computing platform”, the patent No. CN103489003A or US20120066373 entitled “Mobile phone image annotation method based on cloud computing, and the patent No. US20120089726 entitled “Automated service level management of applications in cloud computing environment”, all these patents are applications of cloud computing in client devices and cloud.

### SUMMARY OF THE INVENTION

An objective of the present invent n is to provide a method and device for image processing.

According to one aspect of the present invention, provided is a method for image processing on a user device. The method comprises:

a. performing image processing based on one or more first template elements selected by a user, wherein at least one of the one or more first template elements has a counterpart second template element having an equal or higher resolution; and

b. sending image processing information about the image processing to a corresponding network device, wherein the network device is capable of invoking, the second template element.

According to another aspect of the present invention, further provided is a method for image processing on a network device. The method comprises:

A. obtaining image processing information about image processing, wherein the image processing is performed based on one or more first template elements selected by a user, and at least one of the one or more first template elements has a counterpart second template element having an equal or higher resolution;

B. performing the image processing based on the image processing information by invoking the second template element to obtain a corresponding second image.

According to one aspect of the present invention, further provided is a user device for image processing. The user device comprises:

a first means, configured to perform image processing based on one or more first template elements selected by a user, wherein at least one of the one or more first template elements has a counterpart second template element having an equal or higher resolution; and

a third means, configured to send image processing information about the image processing to the corresponding network device, wherein the network device may invoke the second template element.

According to another aspect of the present invention, further provided is a network device for image processing. The network device comprises:

a second means, configured to obtain image processing information about image processing, wherein the image processing is performed based on one or more first template elements selected by a user, and at least one of the one or more first template elements has a counterpart second template element having an equal or higher resolution; and

a fourth means, configured to perform the image processing based on the image processing information by invoking the second template element to obtain a corresponding second image.

According to further another aspect of the present invention, further provided is a system for image processing. The system comprises a user device for image processing according to one aspect of the present invention as mentioned before, and the network device for image processing according to another aspect of the present invention as mentioned before,

Compared with the prior art, in an embodiment of the present invention, a user device performs image processing based on first template elements selected by a user, wherein at least one of the first templates has a counterpart second template element having an equal or higher resolution; and image processing information about the image processing is sent to a corresponding network device, wherein the network device may invoke the second template element and thus is allowed to perform the image processing based on the image processing information by invoking the second template element, thereby obtaining a second image.

According to the present invention, with a group of template elements (or images) corresponding to different resolutions in a user terminal and a network terminal, design and preview of images may be achieved on the user terminal without network connection, thereby reducing the image processing overhead of the user device and saving the traffic for the user. Accordingly, the user experience of image processing is also enhanced. Moreover, the operation complexity of image processing is reduced, allowing for simple image processing that can satisfy the need of nonprofessional users for image processing and also meets the user's image processing demands such as personalized image design and the like. In addition, in another embodiment of the present invention, image processing may also be performed on a first image based on first template elements selected by a user, and the first image may be an obtained low-resolution image corresponding to an original image which corresponds to network access address information. As a result, the traffic may be further reduced for the user, and the image processing overhead of the user device is further decreased.

### BRIEF DESCRIPTION OF THE DRAWINGS

Other features, objectives and advantages of the present invention will become more apparent from the following detailed descriptions made on non-limiting embodiments with reference to the following figures:

FIG. 1 shows a diagram of a user device and network device for image processing according to one aspect of the present invention;

FIG. 2 shows a diagram of an image obtained by performing image processing based on one or more first template elements selected by a user according to an embodiment of the present invention;

FIG. 3 shows a diagram of an image obtained by performing image processing on a first image based on one or more first template elements selected by a user according to an embodiment of the present invention;

FIG. 4 shows a diagram of a user device and a network device for image processing according to a preferred embodiment of the present invention

FIG. 5 shows a flowchart of a method for image processing implemented by cooperation of a user device and a network device according to another aspect of the present invention; and

FIG. 6 shows a flowchart of a method for image processing implemented by cooperation of a user device and a network device according to a preferred embodiment of the present inv non.

The same or similar drawing marks in the accompanying drawings represent the same or similar parts.

### DETAILED DESCRIPTION OF THE INVENTION

The present invention will be further described in detail below in conjunction with the figures.

As a typical configuration in the present invention, each of a terminal, a device for a service network and a trusted third party may comprise one or more Central Processing Units (CPUs), an input/output interface, a network interface and a memory. The memory may be in the form of a volatile memory, a Random Access Memory (RAM) and/or nonvolatile memory and the like among computer-readable mediums, for example, a Read-Only Memory (ROM) or a flash RAM. The memory is just an example for a computer-readable medium. Computer-readable mediums include permanent and volatile, mobile and fixed media that may achieve information storage by any method or technology. The information may be computer-readable instructions, data structures, modules of programs or other data. Examples for a computer storage medium include but is not limited to: Parameter RAM (PRAM), Static RAM (SRAM) Dynamic RAM (DRAM), other types of RAMS, ROM, Electrically Erasable Programmable Read-Only Memory (EEPROM), flash memory or other memory techniques, Compact Disk ROM (CD-ROM), Digital Video Disk (DVD) or other optical storages, cassette tape, magnetic tape/magnetic disk storages or other magnetic storages, or any other no transmission mediums. All such computer storage mediums may be used for storing information accessible to computing devices. As defined herein, the computer-readable mediums are exclusive of non-transitory computer-readable media, such as modulated data signal and carrier.

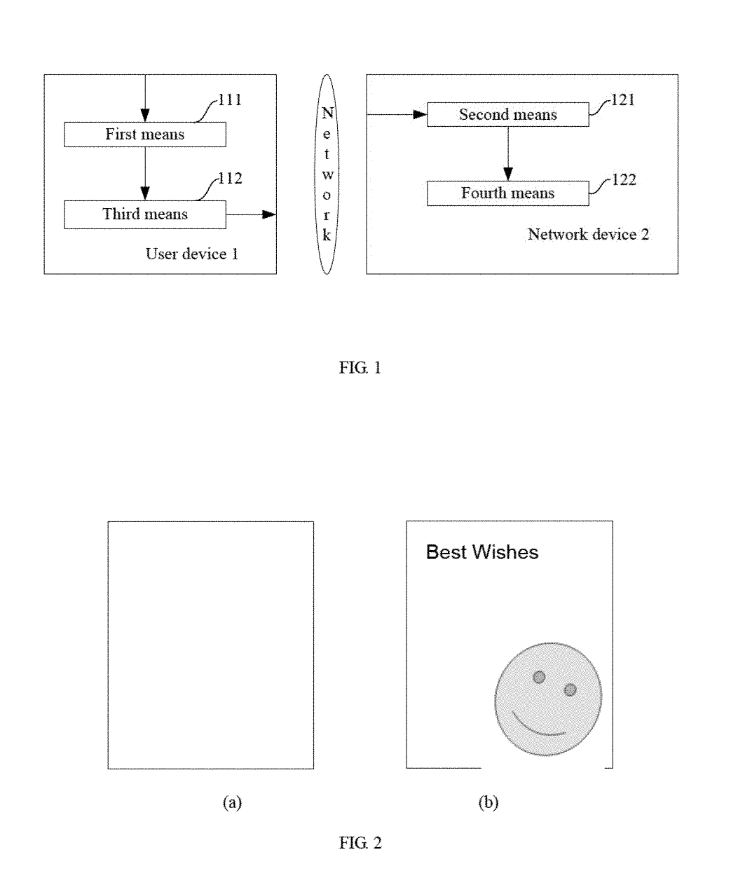

FIG. 1 shows a diagram of a user device 1 and network device 2 for image processing according to one aspect of the present invention, wherein the user device 1 comprises a first means 111 and a third means 112, while the network device 2 comprises a second means 121 and a fourth means 122. Specifically, the first means 111 of the user device 1 performs image processing based on one or more first template elements selected by a user, wherein at least one of the one or more first template elements has a counterpart second template element having an equal or higher resolution. The third means 112 sends image processing information about the image processing to the corresponding network device 2, wherein the network device 2 may invoke the second template element. Correspondingly, the second means 121 of the network device 2 obtains image processing information about image processing, wherein the image processing is performed based on one or more first template elements selected by a user, and at least one of the one or more first template elements has a counterpart second template element having an equal or higher resolution. The fourth means 122 performs the image processing based on the image processing information by invoking the second template element to obtain a corresponding second image.

The user device 1 mentioned herein may be any electronic product that is capable of processing images and interacting with the corresponding network device, and may be enabled to have man-machine interoperation with a user by a keyboard, a mouse, a touch pad, a touch screen, a handwriting device, a remote controller or a voice-operated device, for example, a computer, a mobile phone, a Personal Digital Assistant (PDA), a Palm Personal Computer (PPC), a tablet computer, etc.

The network device 2 mentioned herein may be any server or cloud software platform capable of processing images, and may also be image processing service providing cloud, cloud drive, micro-cloud, and the like. The network device 2 may be implemented by a network host, a single network server, a cluster of a plurality of network servers, a cloud computing-based computer cluster or the like. The cloud mentioned herein is constituted by a great number of cloud computing-based hosts or network servers, wherein cloud computing is a distributed computing and a virtual super computer consisting of a cluster of loosely coupled computers.

The user device 1 and the network device 2 mentioned herein both comprise an electronic device that is able to automatically proceed with numerical computation according to preset or pre-stored instructions, and the hardware of this electronic device includes but is not limited to: a microprocessor, an Application-Specific Integrated Circuit (ASIC), a Field Programmable Gate Array (FPGA), a Digital Signal Processor (DSP), an embedded device, etc. It will be understood by those skilled in the art that the user device 1 and the network device 2 are merely discussed above by way of example, and other user devices or network devices in existence or those that will possibly appear in future, if applicable to the present invention, should also fall into the scope of protection of the present invention and are incorporated herein by reference.

It needs to be noted first herein that images in the present invention include various graphs and images having visual effects.

Specifically, the first means 111 of the user device 1 performs image processing based on one or more first template elements selected by a user, wherein at least one of the one or more first template elements has a counterpart second template element having an equal or higher resolution.

The first template elements mentioned herein include template elements in a bitmap format or a vector format, such as image outline, graph, pattern, shading, font library and the like. A user may carry on further image processing based on the template element(s), for example, scaling up or down a template element, changing the positions of components of another template element therein, or the like. The bitmap mentioned herein is also known as a dot matrix image or a drawn image, which is constituted by single dots called pixels (picture elements), and, for example, cages in such image file formats as tiff and jpeg are bitmap images. Vector, which is also known as an object-oriented image or a graphic image, is an image represented by mathematical equation-based geometric primitives, such as points, straight lines, polygons or the like, in computer graphics. For example, a first template element in the vector format may be represented by a corresponding formula or a description file. The first template elements mentioned herein may be stored in a first template library, and the first template library may be stored in the user device 1.

The image processing herein includes: operations that are performed on the selected first template element by the user in the process of obtaining a desired image based on the selected first template element, such as scaling, rotating, color filling, overlapping, character adding and the like; or, when the first template element comprises a plurality of components, for example, when the first template element is a combination of a plurality of other first template elements, modification, substitution, deletion or other editing operations performed on one or more components therein; or, when the user selects a plurality of first template elements, setting a relative position relation and/or an overlapping sequence relation of the plurality of first template elements, or changing the set overlapping sequence relation of the plurality of first template elements, Performing the image processing comprises generating a corresponding layer file for describing the image processing or a result thereof in response to the image processing performed by the user. For example, the layer file describes information such as position, scaling, color and the like of the corresponding first template element after the user's operations. Particularly, when it comes to a plurality of first template elements, respective layer files are generated separately based on operations performed by the user on the plurality of first template elements, wherein the overlapping sequence for the plurality of layer files corresponds to the sequence of the user's operations on the various first template elements. Preferably, performing the image processing also comprises editing the generated layer files in response to the image processing performed by the user. For example, when the user changes the set overlapping sequence of a plurality of first template elements, the overlapping sequence of a plurality of corresponding layer files is adjusted accordingly based on the changed overlapping sequence of the plurality of first template elements. For another example, when the user re-modifies a first template element T1 after performing operations on the first template element T1 and T2 one after another, the generated layer file corresponding to T1 is edited based on the re-modifying operation. The layer file herein refer to the corresponding first template elements so that the network device 2 can process a second template element corresponding to the first template element; the reference modes thereof include but are not limited to: 1) The layer file contains the identification information of the first template element, for example, the information, such as name access address and the like, of the first template element; 2) the file layer contains the description information of the first template element, for example, the equation description and the like of the first template element in the vector format.

It would be understood by those skilled in the art that: according to this solution, by generating respective layer files corresponding to the first template elements selected by a user to allow processing based on image processing information including the respective layer files on the network device so as to obtain a final image, the image processing overhead, of the user device is effectively reduced with increased efficiency of response, to the user's operations on the first template elements and improved user experience; and when more first template elements are selected by the user, more significant improvement effects may be shown. It would be understood by those skilled in the art that the image processing is described above just by way of example, and other existing or future possible image processing, if applicable to the present invention, should also fall into the scope of protection of the present invention, which are incorporated herein by reference.

The resolution mentioned herein means image resolution. Images having different resolutions may vary in display effect (i.e., the display quality of an image) on the same display device. For example, for a bitmap image, it is related to the resolution of the display device, but for a vector, it is unrelated to the resolution of the display device.

The second template element mentioned herein is a template element high an equal or higher resolution when compared to the first template element. For example, the second template element may be a template element existing in a second template library and corresponding to the first template element, such as image outline, graph, pattern, shading, font library and the like, and in this case, an image obtained based on the second template element is a vector. Alternatively, the second template element may also be a template element in the bitmap format having a resolution higher than that of the first template element. The vector mentioned herein is obtained by graphing based on geometric characteristics, and also known as an object-oriented image or a graphic image. For example, images in such image file formats as .dwg, .def and AI are vectors. The second template library herein may be stored in the network device 2.

For example, an assumption is made that user A is designing a book cover on a mobile device (corresponding to the user device 1): user A first selects a book cover template, for example, book cover template-1 in the rectangular shape as shown in FIG. 2 (a), from a first template library locally stored in the mobile device or provided by the client of image processing software installed in the mobile device, and their adds, a smile template, for example, smile template-1, in the first template library to the bottom right corner of the book cover template-1, and clockwise rotates the smile template-1 30 degrees after gray filling: next, user A adds a text in 14 pt Arial font in the font library of the first template library, for example, “Best Wishes”, to the book cover template, thereby obtaining the image as shown in FIG. 2(b). In such a case, the first means ill of the user device 1 may first obtain, by invoking an Application Interface (API) provided by the user device 1 itself, or by invoking an API provided by image processing software installed in the user device 1, the first template elements including the book cover template-1 and the smile template-1 selected by the user A and the above image processing, e.g., image processing-1, performed by user A on the first template elements, i.e., the operation of adding the smile template-1 to the book cover template-1, the operations of gray filling and clockwise 30-degree rotation on the smile template-1, and the operation of adding a text in 14 pt Arial font in the font library of the first template library, for example, “Best Wishes”, to the book cover template-1, all performed by user A, wherein at least one of the first template elements such as the book cover template-1 and the smile template-1 has a counterpart second template element having an equal or higher resolution.

Preferably, in the process of performing the image processing, the first means 111 also displays the obtained image, for example, respective layer files corresponding to various first template elements generated when performing the image processing. For example, still in the above example, the first means 111 may also display the obtained image as shown in FIG. 2(b) in a preview mode, so that the user can preview the design effect immediately in the image design process. More preferably, the display image herein may also include other layer files, for example, layers corresponding to foil-stamping preview, varnishing preview, application format information, die-cutting setting information and the like, respectively. It would be understood by those skilled in the art that: compared with the prior art of directly generating the final, image on the user device, according to this solution, the respective layer files corresponding to the various first template element generated when the image processing is performed are displayed in the process of performing the image processing, so that the user can preview the image design effect immediately; in addition, it may also support that the user adjusts the generated layer files according to the preview effect; thus, the efficiency of image processing by the user is further increased, and the user experience is improved.

Next, the third means 112 first obtains the image processing information about the image processing, and then sends the image processing information about the image processing to the corresponding network device 2 by agreed communication ways, http and https, wherein the network device 2 may invoke the second template element.

The image processing information mentioned herein includes the one or more first template elements selected by the user when the image processing is performed, and the information of operations such as scaling, rotating, color filling overlapping, character adding and the like performed on the first template element(s), the information about the placing position, size, rotation angle, color change and the like of the first template element after the operations are completed. Preferably, the foregoing information is included in the image processing information in the form of layer file. For example, when the image processing is performed, a corresponding layer file for describing the image processing or a result thereof is generated. For example, the layer file describes information such as position, scaling, color and the like of the corresponding first template element after the user's operations; and then the layer file is put in the image processing information and sent to the network device 2, Particularly, when it comes to a plurality of first template elements, respective layer files are generated separately based on operations performed by the user on the plurality of first template elements, wherein the, overlapping sequence for the plurality of layer files corresponds to the sequence of the user's operations on the plurality of layer files; and then the information such as the layer files and the overlapping sequence thereof is put in the image processing information and sent to the network device 2.

For example, with regard to the image processing, e.g., image processing-1, performed by user A on the selected first template elements including the book cover template and the smile template-1 in the process of forming the desired image as shown in FIG. 2(b), the third means 112 may obtain, via the API provided by the user device 1 itself, the image processing information-1 about the image processing-1, which includes: i) the information of the first template elements including the book cover template and the smile template-1 used by user A; ii) the information of adding the smile template-1 to the book cover template; iii) the information of color change due to gray filling to the smile template-1 and the information of rotation angel of clockwise rotating the smile template-1 30 degrees; iv) the operation information of adding the text in 14 pt Arial font in the font library of the first template library, for example, “Best Wishes”, to the book cover template; and then the third means 112 of the user device 1 may send, for example, the image processing information-1 about the image processing-1 to the corresponding network device 2 by agreed communication ways, e.g., http and https, wherein the network device 2 may invoke the second template element.

Correspondingly, the second means 121 of the network device 2 receives the image processing information about the image processing sent by the user device 1 by agreed communication ways, e.g., http and https, wherein the image processing is performed based on one or more first template elements selected by a user, and at least one of the one or more first template elements has a counterpart second template element having an equal or higher resolution.

Next, the fourth means 122 performs the image processing based on the image processing information by invoking the second template element to obtain a corresponding second image. For example, based on the layer file contained in the image processing information, corresponding image processing is performed on the second template element in the layer file; for example, the corresponding image processing is performed on the second template element based on the position, scaling, color information and the like of the first template element described in the layer file so as to obtain the corresponding second image. Particularly, when it conies to a plurality of first template elements, the image processing information includes a plurality of layer files and overlapping sequence information thereof. Accordingly, corresponding image processing is performed on the second template elements therein based on the plurality of layer files and the second template elements are overlapped according to the overlapping sequence information to obtain the corresponding second image. The second in age mentioned herein is an image having an equal or higher resolution, e.g., a vector, when compared with an image obtained by performing the image process only based on the first template elements.

For example, assuming that the second means 121 of the network device 2 receives the image processing information-1 about the image processing-1 sent by the third means 112 of the user device 1, the second means 121 may, based on the image processing information-1, invoke, for example, second template elements included in a second template library stored in the network device 2 and corresponding to the information of the first template elements including the book cover template-1 and the smile template-1 in the image processing information-1; for example, the second template element corresponding to the book cover template-1 is, for example, book cover template-2, and the second template element corresponding to smile-template-1 is, for example, smile template-2; and the image processing corresponding to the image processing information-1 is performed in the same way as the image processing-1 to obtain the corresponding second image.

The related means of the user device 1 and the network device 2 are capable of operating continuously. Specifically, the third means 112 of the user device 1 continuously sends the image processing information about the image processing to the corresponding network device 2, wherein the network device 2 may invoke the second template element. Correspondingly, the second means 121 of the network device 2 continuously obtains image processing information about image processing, the image processing is performed based on one or more first template elements selected by a user, and at least one of the one or more first template elements has a counterpart second template element having an equal or higher resolution. The fourth means 122 continuously performs the image processing by invoking the second template element based on the image processing information to obtain the corresponding second image. Here, it should be understood by those skilled in the art that “continuously” refers to that the image processing information are continuously sent and received between the related means of the user device 1 and the network device 2, respectively, with the second image being obtained continuously until the user device 1 stops sending the image processing information in a quite long time.

Preferably, the image processing performed by the first means 111 of the user device 1 also comprises at least any one of:
setting application format information for an image obtained by the image processing;
setting die-cutting setting information corresponding to a first template element selected by the user for die-cutting setting:
setting varnishing information corresponding to a first template element selected by the user for varnishing preview; and
setting foil-stamping information corresponding to a first template element selected by the user for foil-stamping preview.

Here, the application format information involves predetermined formats set by the user corresponding to the output (e.g., print) size, image output format and image application (e.g., as book cover or phone shell) of an image obtained through the image processing, etc. Here, the die-cutting setting information involves the cutting area, cutting layer and the like of the first template element selected for die-cutting setting in printing output. For example, when a user selects to set the die-cutting setting information of a first template element, a layer file corresponding to the die-cutting setting information is generated, wherein die-cutting setting information is inward 0.2-3 mm indentation relative to the periphery of the first template element. Here, the varnishing information includes a layer file overlapped on the first template element that is selected by the user for varnishing preview, for example, a white filter layer and/or a layer file for increasing a. color depth difference of the first area relative to the adjoining area. Here, the foil-stamping information includes a layer file overlapped on the first template element that is selected by the user for foil-stamping preview, for example, a single color (yellow or gray) filter layer and a while filter layer overlapped thereon and/or an image projection layer, wherein the image projection layer is used for projecting a diluted image in a layer thereunder. Preferably, the user device 1 generates corresponding layer files when performing the image processing to record the application format information, the die-cutting setting information, the varnishing information or the foil-stamping information, and transfers them to the network device 2 by a similar communication sway to other layer files for performing of corresponding subsequent image processing, which is then not redundantly described herein and just incorporated herein by reference.

Correspondingly, the second image obtained by the fourth means 122 of the network device 2 also includes at least any one of the following;
a layer file corresponding to the application format information set by the user
a layer file corresponding to the die-cutting setting information set by the user;
a layer file corresponding to the varnishing information set by the user;
a layer file corresponding to the foil-stamping information set by the user.

Here, the second image also comprises other layer file(s) for subsequent processing. The other layer file(s) includes but is not limited to a layer corresponding to the application format information set by the user, a layer file corresponding to the die-cutting setting information set by the user, a layer file corresponding to the varnishing information set by the user, and a layer file corresponding to the foil-stamping information set by the user, or any combination thereof.

Preferably, the network device 2 also comprises a sixth means (not shown). Specifically, the sixth means provides the second image to a corresponding image output device by agreed communication ways such as http, https and the like so that the image output device can interpret and output the second image 4. The image output device includes but is not limited to a raster image processor, a printer, an image setter and the like.

Preferably, the network device 2 also comprises an eighth means (not shown). Specifically, the eighth means generates a new corresponding template element based on one or more template elements. For example, a new corresponding template element is generated by combining or overlapping the one of more template elements, or in other ways, and the new template element is provided to the corresponding user device 1 by agreed communication ways, e.g., http and https, for use by the user. Here, the one or more template elements may be the first template elements, and may also be new template elements in the bitmap format.

Here, according to the present invention, generating the new template element on the network device 2 and sending it to the corresponding user device 1, the first template elements on the user device 1 are enriched with enhanced satisfaction of the user in selecting the first template elements and improved image processing convenience, and the user's time for image processing based on the original first template elements is also saved.

Here, it would be understood by those skilled in the art: when image processing is performed by the user based on the new template element, the new template element has no counterpart second template element having an equal or higher resolution, and then the network device 2 may not invoke the second template element. In this case, the network device 2 may invoke the second template element corresponding to an original template element (e.g. the original first template element) from which the new template element is generated, to proceed with corresponding image processing, thereby obtaining the corresponding second image.

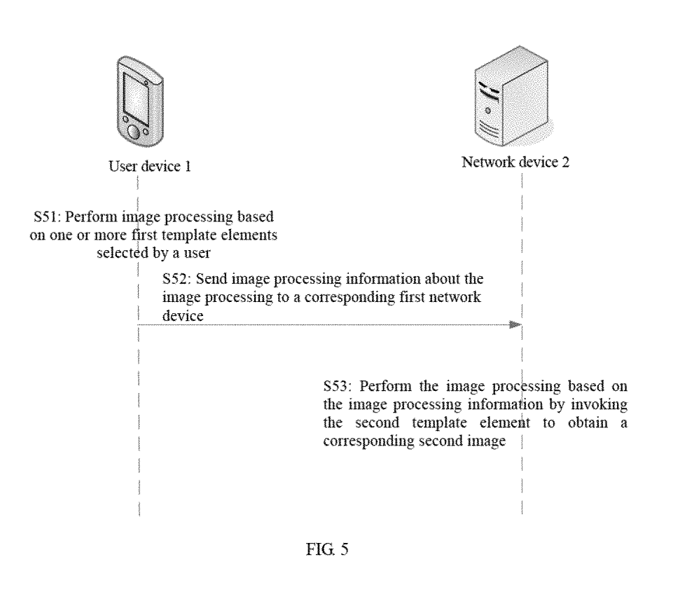

FIG. 4 shows a diagram of a user device 1 and network device 2 for image processing according to a preferred embodiment of the present invention, wherein the user device 1 comprises a first means 411 and a third means 412, while the network device 2 comprises a second means 421 and a fourth means 422. Specifically, the first means 411 of the user device 1 performs image processing on a first image based on one or more first template elements selected by a user, wherein at least one of the one or more first template elements has a counterpart second template element having an equal or higher resolution. The second means 412 sends image processing information about the first image and the image processing to the corresponding network device 2, wherein the network device 2 may invoke the second template element. Correspondingly, the second means 421 of the network device 2 obtains image processing information about a first image and the image processing, wherein the image processing is performed on the first image based on one or more first template elements selected by a user, and at least one of the one or more first template elements has a counterpart second template element having an equal or higher resolution. The fourth means 422 performs the image processing on the first image based on the image processing information by invoking the second template element to obtain a corresponding second image.

Specifically, the first means 411 of the user device 1 may first obtain, by invoking an Application Interface (API) provided by the user device 1 itself or by invoking an API provided by image processing software installed in the user device 1, one or more first template elements selected by the user and a first image imported by the user. Next, the image processing performed by the user on the first image based on the one or more selected first template elements is obtained, wherein at least one of the one or more first template elements has a counter part second template element having an equal or higher resolution. The first image mentioned herein may be locally obtained from the user device 1, and may also be picked up in real time by the user device 1, and may further be obtained from a device, e.g., a server, which is in connection with the user device 1 by way of a network, wherein the first image may be a high-resolution image in the bitmap format, or a low-resolution image in the bitmap format.

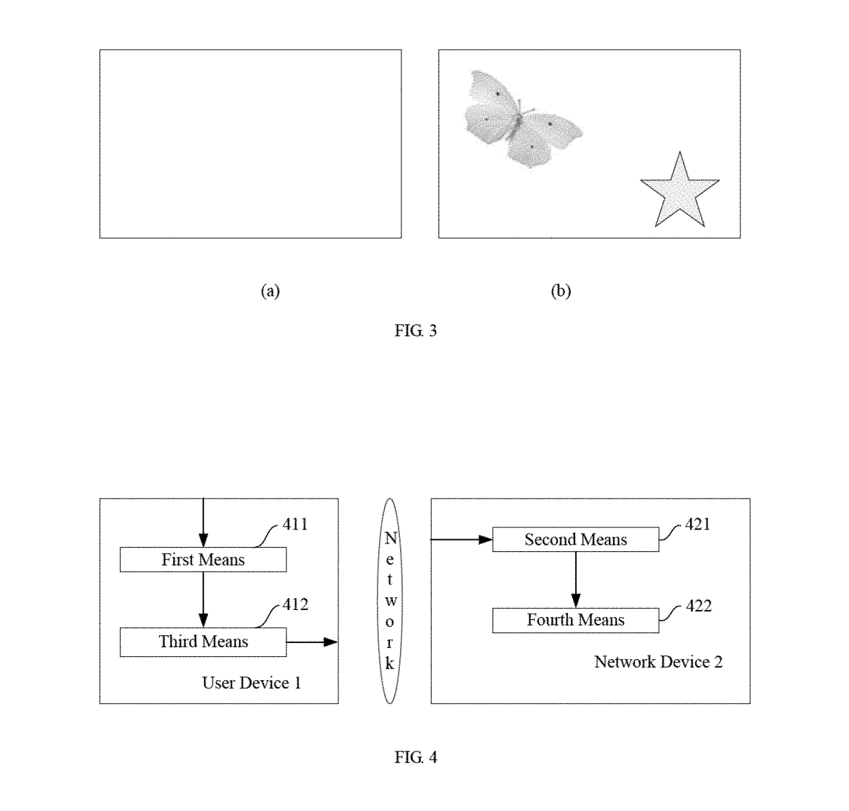

For example, an assumption is made on that user A is designing a phone shell on a mobile device (corresponding to the user device 1): User A first selects from a first template library locally stored by the mobile device or provided by the client of image processing software installed in the mobile device a phone shell contour template phone shell-2 in a rectangular shape as shown in FIG. 3(a); next, user A imports the picked-up first image e.g. a low-resolution butterfly image, into the phone shell-2, and then performs the operations of adjusting the size of the bitmap butterfly image, placing the butterfly image at the top left corner of the phone shell-2, clockwise rotating it 45 degrees and changing its color from dark green into light gray; next, user A imports a template five-pointed star-2. from the first template library, and adjusts the size of the five-pointed star and fills it with white color, thereby obtaining an image shown in FIG. 3(b). In such a case, the first means 411 of the user device 1 may first obtain, by invoking an Application Interface (API) provided by the user device 1 itself, or by invoking an API provided by image processing software installed in the user device 1, the first template elements including the phone shell-1 and the five-pointed star-2 selected by user A, the first image or butterfly image imported by user A. and the above image processing performed by user A on the first template elements and the first image, e.g., image processing-2, i.e., the operation of adding the five-pointed star-2 and the first image or butterfly image to the phone shell-2, the operations of gray change and clockwise 45-degree rotation on the butterfly image, and the operation of color filling to the five-pointed star-2, all performed by user A, wherein at least one of such first template elements as phone shell-1 and five-pointed star-2 has a counterpart second template element having an equal or higher resolution.

Preferably, the first means 411 may first reduce the resolution of the first image first, for example, by compressing the first image into a low-resolution bitmap image, and then may perform image processing on the resolution reduced first image based on one or more first template elements selected by the user, wherein at least one of the one or more first template elements has a counterpart second template element having an equal or higher resolution. Here, the mode in which the first means 411 performs image processing on the resolution reduced first image based on the one or more first template elements selected by the user is the same or basically the same as the aforementioned mode in which the first means 411 performs image processing on the first image based on the one or more first template elements selected by the user, which is then not redundantly described herein for the sake of conciseness and incorporated herein by reference. Here, by reducing resolution of the first image, the traffic of the user device is reduced and especially for a mobile device, according to the present invention, the traffic may be saved significantly and the image processing overhead of the mobile device is reduced under the circumstance of restricted traffic; and accordingly, the user's traffic spending is reduced.

Next, the second means 412 first obtains the image processing information about the first image and the image processing, and then sends the image processing information to the corresponding network device 2, wherein the network device may invoke the second template element. Here, the image processing information about the first image and the image processing is identical or close to the image processing information about the image processing in FIG. 1 in content. For example, the information of processing on the first image by the user, such as the scaling information, image size information, position information, color change information, rotation angle information and the like about the first image, is added on the basis of the image processing information of the image processing.

The mode in which the second means 412 obtains the image processing information about the first image and the image processing is the same or basically the same as the mode in which the second means 112 obtains the image processing information about the image processing in FIG. 1, which is then not redundantly described herein for the sake of conciseness and incorporated herein by reference.

Correspondingly, the second means 421 of the network device 2 obtains image processing information about a first image and the image processing, for example, receives the image processing information about the first image and the image processing sent by the corresponding user device 1, wherein the image processing is performed on the first image based on one or more first template elements selected by a user, and at least one of the one or more first template elements has a counterpart second template element having an equal or higher resolution.

The fourth means 422 performs the image processing on the first image based on the image processing information by invoking the second template element to obtain a corresponding second image. Here, the mode in which the fourth means 422 obtains the corresponding second image is the same or basically the same as the mode in which the fourth means 122 obtains the corresponding second image in FIG. 1, which is then not redundantly described herein for the sake of conciseness and incorporated herein by reference.

Preferably, the user device 1 also comprises a fifth means (not shown). Specifically, the fifth means may obtain a low-resolution image corresponding to an original image that corresponds to network access address information via an Application Interface (API) provided by third-party devices including a browser and an image providing server, i.e., obtain the low-resolution image directly provided by each of these third-party devices as the first image.

For example, an assumption is made on that user A is designing a phone shell on a mobile device (corresponding to the user device 1): User A first selects from a first template library locally stored by the mobile device or provided by the client of image processing software installed in the mobile device a phone shell contour template phone shell-2 in a rectangular shape as shown in FIG. 3(a); next, user A wants to import an image stored in a network disk, and clicks on the image insertion button, selects “Insert An Image From A network Disk”, enters a network access address e.g., URL1, corresponding to the network disk , and clicks an image in a folder therein, e.g., photo1 (its corresponding network access address is URL1\Folder1\photo1), thereby sending an image access request to the network disk. In this case, the fifth means may receive an original image corresponding to the network access address information URL1\folder1\photo1 that is returned by the network disk on the image access request, i.e., a low-resolution image corresponding to photo1, and use this image as the first image.

Here, according to the present invention, low-resolution images directly provided by third-party devices are obtained as the first images, and thus, the traffic may be further reduced for the user, and the image processing overhead of the user device is further reduced.

More preferably, when the second means 412 of the user device 1 sends the image processing information about the first image and the image processing to the network device 2, the image processing information includes the network access address information.

For example, still in the above example, when the second means 412 sends the image processing information about the first image and the image processing to the network device 2, the image processing information includes the network access address information URL1\folder1\photo1 of photo1.

Correspondingly, the image processing information obtained by the second means 421 of the network device 2 includes the network access address information URL1\folder1\photo1 of photo1.

The fourth means 422 of the network device 2 may also first obtain an original image corresponding to the network address information; for example, this means submits an image access request to a device corresponding to the network access address information, and receives the original image corresponding to the network access address information returned by the corresponding device; next, the image processing is performed on the original image by invoking the second template element based on the image processing information to obtain the corresponding second image. Here, the mode in which the fourth means 422 obtains the corresponding second image is the same or basically the same as the mode in which the fourth means 122 obtains the corresponding second image in FIG. 1, which is then not redundantly described herein for the sake of conciseness and incorporated herein by reference.

Here, according to the present invention, when the second means 412 sends the image processing information about the first image and the image processing to the network device 2, instead of sending the first image, only the network access address information of the original image corresponding to the low-resolution image serving as the first image needs to be sent. Thus, upon obtaining the corresponding second image, the network device 2 may first automatically obtain the corresponding original image according to the network access address information, thereby further reducing the traffic for the user and further keeping the image processing overhead of the user device down with improved image processing response efficiency.

FIG. 5 shows a flowchart of a method for image processing implemented by cooperation of a user device and a network device according to another aspect of the present invention.

The method therein comprises step S51, step S52 and step S53. Specifically, in step S51, the user device 1 performs image processing based on one or more first template elements selected by a user, wherein at least one of the one or more first template elements has a counterpart second template element having an equal or higher resolution; in step S52, the user device 1 sends image processing information about the image processing to the corresponding network device 2, wherein the network device 2 may invoke the second template element. Correspondingly, the network device 2 obtains image processing information about image processing, wherein the image processing is performed based on one or more first template elements selected by a user, and at least one of the one or more first template elements has a counterpart second template element having an equal or higher resolution. In step S53, the network device 2 performs the image processing based on the image processing information by invoking the second template element to obtain a corresponding second image.

The user device 1 mentioned herein may be any electronic product that is capable of processing images and interacting with the corresponding network device, and may be enabled to have man-machine interoperation with a user by a keyboard, a mouse, a touch pad, a touch screen, a handwriting device, a remote controller or a voice-operated device, for example, a computer, a mobile phone, a Personal Digital Assistant (PDA), a Palm Personal Computer (PPC), a tablet computer, etc.

The network device 2 mentioned herein may be any server or cloud software platform capable of processing images, and may also be image processing service providing cloud, cloud drive, micro-cloud, and the like. The network device 2 may be implemented by a network host, a single network server a cluster of a plurality of network servers, a cloud computing-based computer cluster or the like. The cloud mentioned herein is constituted by a great number of cloud computing-based hosts or network servers, wherein cloud computing is a distributed computing and a virtual super computer consisting of a cluster of loosely coupled computers.

The user device 1 and the network device 2 mentioned herein both comprise an electronic device that is able to automatically proceed with numerical computation according to preset or pre-stored instructions, and the hardware of this electronic device includes but is not limited to: a microprocessor, an Application-Specific Integrated Circuit (ASIC), a Field Programmable Gate Array (FPGA), a Digital Signal Processor (DSP), an embedded device, etc. It will be understood by those skilled in the art that the user device 1 and the network device 2 are merely discussed above by way of example, and other user devices or network devices in existence or those that will possibly appear in future, if applicable to the present invention, should also fall into the scope of protection of the present invention and are incorporated herein by reference.

It needs to be noted first herein that images in the present invention include various graphs and images having visual effects.

Specifically, in step S51, the user device 1 performs image processing based on one or more first template elements selected by a user, wherein at least one of the one or more first template elements has a counterpart second template element having an equal or higher resolution.

The first template elements mentioned herein include template elements in a bitmap format or a vector format such as image outline, graph pattern, shading, font library and the like. A user may carry on further image processing based on the template element(s), for example, scaling up or down a template element, changing the positions of components of another template element therein, or the like. The bitmap mentioned herein is also known as a dot matrix image or a drawn image, which is constituted by single dots called pixels (picture elements), and, for example, images in such image file formats as tiff and jpeg are bitmap images. Vector, which is also known as an object-oriented image or a graphic image, is an image represented by mathematical equation-based geometric primitives, such as points, straight lines polygons or the like, in computer graphics. For example, a first template element in the vector format may be represented by a corresponding formula or a description file. The first template elements mentioned herein may be stored in a first template library, and the first template library may be stored in the user device 1.

The image processing herein includes: Operations that are performed on the selected first template element by the user in the process of obtaining a desired image based on the selected first template element, such as scaling, rotating, color filling, overlapping, character adding and the like; or, when the first template element comprises a plurality of components, for example, when the first template element is a combination of a plurality of other first template elements, modification, substitution, deletion or other editing operations performed on one or more components therein; or, when the user selects a plurality of first template elements, setting a relative position relation and/or an overlapping sequence relation of the plurality of first template elements, or changing the set overlapping sequence relation of the plurality of first template elements. Performing the image processing comprises generating a corresponding layer file for describing the image processing or a result thereof in response to the image processing performed by the user. For example, the layer file describes information such as position, scaling, color and the like of the corresponding first template element after the user's operations. Particularly, when it comes to a plurality of first template elements, respective layer files are generated separately based on operations performed by the user on the plurality of first template elements, wherein the overlapping sequence for the plurality of layer files corresponds to the sequence of the user's operations on the various first template elements. Preferably, performing the image processing also comprises editing the generated layer files in response to the image processing performed by the user. For example, when the user changes the set overlapping sequence of a plurality of first template elements, the overlapping sequence of a plurality of corresponding layer files is adjusted accordingly based on the changed overlapping sequence of the plurality of first template elements. For another example, when the user re-modifies a first template element. T1 after performing operations on the first template element T1 and T2 one after another, the generated layer file corresponding to T1 is edited based on the re-modifying operation. The layer file herein refer to the corresponding first template elements so that the network device 2 can process a second template element corresponding to the first template element; the reference modes thereof include but are not limited to: 1) The layer file contains the identification information of the first template element, for example, the information, such as name, access address and the like, of the first template element; 2) the file layer contains the description information of the first template element, for example, the equation description and the like of the first template element in the vector format.

It would be understood by those skilled in the art that: According to this solution, by generating respective layer files corresponding to the first template elements selected by a user to allow processing based on image processing information including the respective layer files on the network device so as to obtain a final image, the image processing overhead of the user device is effectively reduced with increased efficiency of response the user's operations on the first template elements and improved user experience; and when more first template elements are selected by the user, more significant improvement effects may be shown. It would be understood by those skilled in the art that the image processing is described above just by way of example, and other existing or future possible image processing, if applicable to the present invention, should also fall into the scope of protection of the present invention, which are incorporated herein by reference.

The resolution mentioned herein is image resolution. Images having different resolutions may vary in display effect (i.e., the display quality of an image) on the same display device. For example, for a bitmap image, it is related to the resolution of the display device, but for a vector, it is unrelated to the resolution of the display device.

The second template element mentioned herein is a template element high an equal or higher resolution when compared to the first template element. For example, the second template element may be a template element existing in a second template library and corresponding to the first template element, such as image outline, graph, pattern, shading, font library and the like, and in this case, an image obtained based on the second template element is a vector. Alternatively, the second template element may also be a template element in the bitmap format having a resolution higher than that of the first template element. The vector mentioned herein is obtained by graphing based on geometric characteristics, and also known as an object-oriented image or a graphic image. For example, images in such image file formats as dwg, dxf and AI are vectors. The second template library herein may be stored in the network device 2.

For example, an assumption is made on that user A is designing a book cover on a me bile device (corresponding to the user device 1); User A first selects a book cover template, for example, book cover template-1 in the rectangular shape as shown in FIG. 2 (a), from a first template library locally stored in the mobile device or provided by the client of image processing software installed in the mobile device, and then adds a smile template, for example, smile template-1, in the first template library to the bottom right corner of the book cover template-1, and clockwise rotates the smile template-1 30 degrees after gray filling; next, user A adds a text in 14 pt Arial font in the font library of the first template library for example, “Best Wishes”, to the book cover template, thereby obtaining the image as shown in FIG. 2(b). In step S51, the user device 1 may first obtain, by invoking an Application Interface (API) provided by the user device 1 itself, or by invoking an API provided by image processing software installed in the user device 1, the first template elements including the book cover template-1 and the smile template-1 selected by the user A and the above image processing, e.g., image processing-1, performed by user A on the first template elements, i.e., the operation of adding the smile template-1 to the book cover template-1, the operations of gray filling and clockwise 30-degree rotation on the smile template-1, and the operation of adding a text in 14 pt Arial font in the font library of the first template library, for example, “Best Wishes”, to the book cover template-1, all performed by user A, wherein at least one of the first template elements such as the book cover template-1 and the smile template-1 has a counterpart second template element having an equal or higher resolution.

Preferably, in the process of performing the image processing, in step S51, the user device 1 also displays the obtained image, for example, respective layer files corresponding to various first template elements generated when performing the image processing. For example, still in the above example, in step S51, the user device 1 may also display the obtained image as shown in FIG. 2(b) in a preview mode so that the user can preview the design effect immediately in the image design process. More preferably, the display image herein may also include other layer files, for example, layers corresponding to foil-stamping preview, varnishing preview, application format information, die-cutting setting information and the like, respectively. It would be understood by those skilled in the art that; Compared with the prior art of directly generating the final image on the user device, according to this solution, the respective layer files corresponding to the various first template element generated when the image processing is performed are displayed in the process of performing the image processing, so that the user can preview the image design effect immediately; in addition, it may also support that the user adjusts the generated layer files according to the preview effect; thus, the efficiency of image processing by the user is further increased, and the user experience is improved.

Next, in step S52, the user device 1 first obtains the image processing information about the image processing, and then sends the image processing information about the image processing to the corresponding network device 2 by agreed communication ways, e.g., http and https, wherein the network device 2 may invoke the second template element. The image processing information mentioned herein includes the one or more first template elements selected by the user when the image processing is performed, and the information of operations such as scaling, rotating, color filling, overlapping, character adding and the like performed on the first template element(s), the information about the placing position, size, rotation angle, color change and the like of the first template element after the operations are completed. Preferably, the foregoing information is included in the image processing information in the form of layer file. For example, when the image processing is performed, a corresponding layer file for describing the image processing or a result thereof is generated. For example, the layer file describes information such as position, scaling, color and the like of the corresponding first template element after the user's operations; and then the layer file is put in the image processing information and sent to the network device 2. Particularly, when it comes to a plurality of first template elements, respective layer files are generated separately based on operations performed by the user on the plurality of first template elements, wherein the overlapping sequence for the plurality of layer files corresponds to the sequence of the user's operations on the various first template elements; and then the information such as the layer files and the overlapping sequence thereof is put in the image processing information and sent to the network device 2.

For example, with regard to the image processing, e.g., image processing-1, performed by user A on the selected first template elements including the book cover template and the smile template-1 in the process of forming the desired image as shown in FIG. 2(b). in step S52, the user device 1 may obtain, via the API provided by itself, the image processing information-1 about the image processing-1, which includes: i) the information of the first template elements including the book cover template and the smile template-1 used by user A; ii) the information of adding the smile template-1 to the book cover template; iii) the information of color change due to gray filling to the smile template-1 and the information of rotation angel of clockwise rotating the smile template-1 30 degrees; iv) the operation information of adding the text in 14 pt Arial font in the font library of the first template library, for example, “Best Wishes”, to the book cover template; and then, in step S52, the user device 1 may send, for example, the image processing information-1 about the image processing-1 to the corresponding network device 2 by agreed communication ways, e.g., http and https wherein the network device 2 may invoke the second template element.

Corresponding the network device 2 receives the image processing information about the image processing sent by the user device 1 by agreed communication ways, e.g., http and https, wherein the image processing is performed based on one or more first template elements selected by a user, and at least one of the one or more first template elements has a counterpart second template element having an equal or higher resolution.

Next, in step S53, the network device 2 performs the image processing. based on the image processing information by invoking the second template element to obtain a corresponding second image. For example based on the layer file contained in the image processing information, corresponding image processing is performed on the second template element in the layer file; for example, the corresponding image processing is performed on the second template element based on the position, scaling, color information and the like of the first template element described in the layer file so as to obtain the corresponding second image. Particularly, when it comes to a plurality of first template elements, the image processing information includes a plurality of layer files and overlapping sequence information thereof. Accordingly, corresponding image processing is performed on the second template elements therein based on the plurality of layer files and the second template elements are overlapped according to the overlapping sequence information to obtain the corresponding second image. The second image mentioned herein is an image having an equal or higher resolution, e.g., a vector, when compared with an image obtained by performing the image process only based on the first template elements.

For example, assuming that the network device 2 receives the image processing information-1 about the image processing-1 sent by the user device 1 in step S52 the network device 2 may, based on the image processing information-1, invoke, for example, second template elements included in a second template library stored in the network device 2 and corresponding to the information of the first template elements including the hook cover template-1 and the smile template-1 in the image processing information-1 in step S52; for example, the second template element corresponding to the book cover template-1 is, for example, book cover template-2, and the second template element corresponding to smile-template-1 is, for example, smile template-2; and the image processing corresponding to the image processing information-1 is performed in the same way as the image processing-1 obtain the corresponding second image.

Continuous operating may be achieved between related steps of the user device 1 and the network device 2. Specifically, in step S52, the user device 1 continuously sends the image processing information about the image processing to the corresponding network device 2, wherein the network device 2 may invoke the second template element. Correspondingly, the network device 2 continuously obtains image processing information about image processing, wherein the image processing is performed based on one or more first template elements selected by a user, and at least one of the one or more first template elements has a counterpart second template element having an equal or higher resolution. In step S53, the network device 2 continuously performs the image processing by invoking the second template element based on the image processing information to obtain the corresponding second image. Here, it should be understood by those skilled in the art, that “continuously” refers to that the image processing information are continuously sent and received between the related steps of the user device 1 and the network device 2, respectively, with the second image being obtained continuously until the user device 1 stops sending the image processing information in a quite long time.

Preferably, in step S51, the image processing performed by the user device 1 also comprises at least any one of:
setting application format information for an image obtained by the image processing;
setting die-cutting setting information corresponding to a first template element selected by the user for die-cutting setting;
setting varnishing information corresponding to a first template element selected by the user for varnishing preview; and
setting foil-stamping information corresponding to the first template element selected by the user for foil-stamping preview.

Here, the application format information involves predetermined formats set by the user corresponding to the output (e.g. print) size, image output format and image use (e.g., as a book cover or phone shell) of an image obtained through the image processing, etc. Here, the die-cutting setting information involves the cutting area, cutting layer and the like of the first template element selected for die-cutting setting in printing output. For example, when a user selects to set the die-cutting setting information of a first template element, a layer file corresponding to the die-cutting setting information is generated, wherein die-cutting setting information is inward 0.2-3 mm indentation relative to the periphery of the first template element. Here, the varnishing information includes a layer file overlapped on the first template element that is selected by the user for varnishing preview, for example, a white filter layer and/or a layer file for increasing a color depth difference of the first. area relative to the adjoining area. Here, the foil-stamping information includes a layer file overlapped on the first template element that is selected by the user for foil-stamping preview, for example, a single color (yellow or gray) filter layer and a while filter layer overlapped thereon and/or an image projection layer, wherein the image projection layer is used for projecting a diluted image in a layer thereunder. Preferably, the user device 1 generates corresponding layer files when performing the image processing to record the application format information, the die-cutting setting information, the varnishing information or the foil-stamping information, and transfers them to the network device 2 by a similar communication sway to other layer files for performing of corresponding subsequent image processing, which is then not redundantly described herein and just incorporated herein by reference.

Correspondingly, the second image obtained by the fourth means 122 of the network device 2 also includes at least any one of:
a layer file corresponding to the application format information set by the user;
a layer file corresponding to the die-cutting setting information set by the user
a layer file corresponding to the varnishing information set by the user;
a layer file corresponding to the foil-stamping information set by the user.

Here, the second image also comprises other layer file(s) for subsequent processing. The other layer file(s) includes but is not limited to a layer corresponding to the application format information set by the user, a layer file corresponding to the die-cutting setting information set by the user, a layer file corresponding to the varnishing information set by the user, and a layer file corresponding to the foil-stamping information set by the user, or any combination thereof.

Preferably, the method also comprises step S54 (not shown). Specifically, in step S54, the network device 2 provides the second image to a corresponding image output device by agreed communication ways such as http, haps and the like so that the image output device can interpret and output the second image. The image output device includes but is not limited to a raster image processor, a printer, an image setter and the like.

Preferably, the method also comprises step S55 (not shown). Specifically, in step S55, the network device 2 generates a new corresponding template element based on one or more template elements. For example, a new corresponding template element is generated by combining or overlapping the one or more template elements, or in other ways, and the new template element is provided to the corresponding user device 1 by agreed communication ways, e.g., http and https, for use by the user. Here, the one or more template elements may be the first template elements, and may also be new template elements in the bitmap format.

Here, according to the present, invention, generating the new template element on the network device 2 and sending it to the corresponding user device 1, the first template elements on the user device 1 are enriched with enhanced satisfaction of the user in selecting the first template elements and improved image processing convenience, and the user's time for image processing based on the original first template elements is also saved.

Here, it would be understood by those skilled in the art: When image processing is performed by the user based on the new template element, the new template element has no counterpart second template element having an equal or higher resolution, and then the network device 2 may not invoke the second template element. In this case, the network device 2 may invoke the second template element corresponding to an original template element (e.g. the original first template element) from which the new template element is generated, to proceed with corresponding image processing, thereby obtaining the corresponding second image.

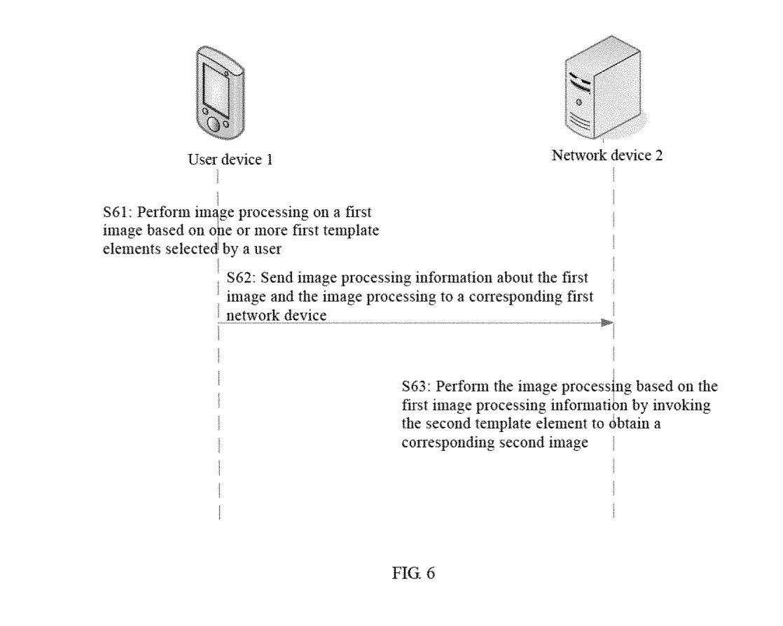

FIG. 6 shows a flowchart of a method for image processing implemented by cooperation of a user device and a network device according to a preferred embodiment of the present invention.

The method therein comprises step S61, step S62 and step S63. Specifically, in step S61, the user device 1 user device 1 performs image processing on a first image based on one or more first template elements selected by a user, wherein at least one of the one or more first template elements has a counterpart second template element having an equal or higher resolution. In step S62, the user device 1 sends the image processing information about the first image and the image processing to the corresponding network device 2, wherein the network device 2 may invoke the second template element. Correspondingly, the network device 2 obtains image processing information about a first image and the image processing wherein the image processing is performed on the first image based on one or more first template elements selected by a user, and at least one of the one or more first template elements has a counterpart second template element having an equal or higher resolution. In step S63, the network device 2 performs the image processing on the first image based on the image processing information by invoking the second template element to obtain a corresponding second image.

Specifically, in step S61, the user device 1 may first obtain, by invoking an Application Interface (API) provided by the user device 1 itself, or by invoking an API provided by image processing software installed in the user device 1, one or more first template elements selected by the user and a first image imported by the user. Next, the image processing performed by the user on the first image based on the one or more selected first template elements is obtained, wherein at least one of the one or more first template elements has a counterpart second template element having an equal or higher resolution. The first image mentioned herein may be locally obtained from the user device 1, and may also be picked up in real time by the user device 1, and may further be obtained from a device, e.g., a server, which is in connection with the user device 1 by way of a network, wherein the first image may be a high-resolution image in the bitmap format, or a low-resolution image in the bitmap fours

For example, an assumption is made on that user A is designing a phone shell on a mobile device (corresponding to the user device 1): user A first selects from a first template library locally stored by the mobile device or provided by the client of image processing software installed in the mobile device a phone shell contour template phone shell-2 in a rectangular shape as shown in FIG. 3(a) next, user A imports the picked-up first image e.g. a low-resolution butterfly image, into the phone shell-2, and then performs the operations of adjusting the size of the bitmap butterfly image, placing the butterfly image at the top left corner of the phone shell-2, clockwise rotating it 45 degrees and changing its color from dark green into light gray; next, user A imports a template five-pointed star-2 from the first template library, and adjusts the size of the five-pointed star and fills it with white color, thereby obtaining an image shown in FIG. 3(b). In such a case, in step S61, the user device 1 may first obtain, by invoking an Application Interface (API) provided by itself or by invoking an. API provided by image processing software installed in the user device 1, the first template elements including the phone shell-1 and the five-pointed star-2 selected by the user A, the first image or butterfly image imported by user A, and the above image processing performed by user A on the first template elements and the first image, e.g., image processing-2, i.e., the operation of adding the five-pointed star-2 and the first image or butterfly image to the phone shell-2, the operations of gray change and clockwise 45-degree rotation on the butterfly image, and the operation of color filling to the five-pointed star-2, all performed by user A, wherein at least one of such first template elements as phone shell-1 and five-pointed star-2 has a counterpart second template element having an equal or higher resolution.

Preferably, in step S61, the user device 1 may first reduce the resolution of the first image first, for example, by compressing the first image into a low-resolution bitmap image, and then may perform image processing on the resolution reduced first image based on one or more first template elements selected by the user, wherein at least one of the one or more first template elements has a counterpart second template element having an equal or higher resolution. Here, in step S61, the mode in which the user device 1 performs image processing on the resolution reduced first image based on the one or more first template elements selected by the user is the same or basically the same as the aforementioned mode in which the user device 1 performs image processing on the first image based on the one or more first template elements selected by the user in step S61, which is then not redundantly described herein for the sake of conciseness and incorporated herein by reference. Here, by reducing the resolution of the first image, the traffic of the user device is reduced, and especially for a mobile device, according to the present invention, the traffic may be saved significantly and the image processing overhead of the mobile device is reduced under the circumstance of restricted traffic; and accordingly, the user's traffic spending is reduced.

Next, in step S62, the user device 1 first obtains the image processing information about the first image and the image processing, and then sends the image processing information to the corresponding network device 2, wherein the network device may invoke the second template element. Here, the image processing information about the first image and the image processing is identical or close to the image processing information about the image processing in FIG. 5 in content. For example, the information of processing on the first image by the user, such as the scaling information, image size information, position information, color change information, rotation angle information and the like about the first image, is added on the basis of the image processing information of the image processing.

Here, in step S62, the mode in which the user device 1 obtains the image processing information about the first image and the image processing is the same or basically the same as the mode in which it obtains the image processing information about the image processing in step S52 in FIG. 5, which is then not riot redundantly described herein for the sake of conciseness and incorporated herein by reference.

Correspondingly, the network device 2 obtains image processing information about a first image and the image processing, for example, receives the image processing information about the first image and the image processing sent by the corresponding user device 1, wherein the image processing is performed on the first image based on one or more first template elements selected by a user, and at least one of the one or more first template elements has a counterpart second template element having an equal or higher resolution.

In step S63, the network device 2 performs the image processing on the first image based on the image processing information by invoking the second template element to obtain a corresponding second image. Here, the mode in which the network device 2 obtains the corresponding second image in step S63 is the same or basically the same as the mode in which it obtains the corresponding second image in step S53 in FIG. 5, which is then not redundantly described herein for the sake of conciseness and incorporated herein by reference.

Preferably, the method also comprises a step S66 (not shown). Specifically, in step S66, the user device 1 may obtain a low-resolution image corresponding to an original image, which corresponds to network access address information via an Application Interface (API) provided by third-party devices including a browser and an image providing server i.e., obtain the low-resolution image directly provided by each of these third-party devices as the first image.

For example, an assumption is made on that user A is designing a phone shell on a mobile device (corresponding to the user device 1): User A first selects from a first template library locally stored by the mobile device or provided by the client of image processing software installed in the mobile device a phone shell contour template phone shell-2 in a rectangular shape as shown in FIG. 3(a); next, user A wants to import an image stored in a network disk, and clicks on the image insertion button, selects “Insert An Image From A network Disk”, enters a network access address, e.g., URL1, corresponding to the network disk, and clicks an image in a folder therein, e.g., photo1 (its corresponding network access address is URL1\Folder1\photo1), thereby sending an image access request to the network disk. In this case, in step S66, the user device 1 may receive an original image corresponding to the network access address information URL1\folder1\photo1 that is returned by the network disk on the image access request, i.e., a low-resolution image corresponding to photo 1, and use this image as the first image.

Here, according to the present invention, low-resolution images directly provided by third-party devices are obtained as the first images, and thus, the traffic may be further reduced for the user, and the image processing overhead of the user device is further reduced.

More preferably, in step S62, when the user device 1 sends the image processing information about the first image and the image processing to the network device 2, the image processing information includes the network access address information.

For example still in the above example, in step S62, when the user device 1 sends the image processing information about the first image and the image processing to the network device 2, the image processing information includes the network access address information URL1\folder1\photo1 of photo1.

Correspondingly, the image processing information obtained by the network device 2 includes the network access address information URL1\folder1\photo1 of photo1.

In step S63, the network device 2 may also first obtain an original image corresponding to the network address information; for example, this means submits image access request a device corresponding to the network access address information, and receives the original image corresponding to the network access address information returned by the corresponding device; next, the image processing is performed on the original image by invoking the second template element based on the image processing information to obtain the corresponding second image. Here, the mode in which the network device 2 obtains the corresponding second image in step S63 is the same or basically the same as the mode in which it obtains the corresponding second image in step S53 in FIG. 5, which is then not redundantly described herein for the sake of conciseness and incorporated herein by reference.

Here, according to the present invention, in step S62, when the user device 1 sends the image processing information about the first image and the image processing to the network device 2, instead of sending the first image, only the network access address information of the original image corresponding to the low-resolution image serving as the first image needs to be sent. Thus, upon obtaining the corresponding second image, the network device 2 may first automatically obtain the corresponding original image according to the network access address information, thereby further reducing the traffic for the user and further keeping the linage processing overhead of the user device down with improved image processing response efficiency.

It needs to be noted that the present invention may be implemented by software and/or a combination of software and hardware, for example, by an application-specific integrated circuit (ASIC), a general-purpose computer or any other similar hardware devices. In air embodiment, a software program in the present invention may be executed by a processor to achieve the steps or functions as mentioned above. Similarly, the software program in the present invention (including related data structures) may be stored to a computer-readable recording medium, for example, Random Access Memory (RAM), magnetic or optical driver or floppy disk cartridge and similar devices. In addition, some steps or functions in the present invention may be implemented by hardware, for example, a circuit cooperating with a processor to execute various steps and functions.

In addition, part of the present invention may be used as a computer program product, for example, computer program instructions that, when executed by a computer, may invoke or provide the method and/or the technical solution in the present invention via operations of the computer. Program instructions invoking the method in the present invention may be stored in a fixed or mobile recoding medium, and/or transmitted by data streams in broadcasting or other signal bearer medias, and/or stored in a working memory of a computing device operating according to the program instructions. Here, an embodiment of the present invention comprises a means including a memory for storing computer program instructions and a processor for executing program instructions, wherein when the computer program instructions, when executed by the processor, may trigger the means to rim a method and or technical solution based on above-mentioned various embodiments according to the present invention.

It would be understood by those skilled in the art that the present invention is not limited to details of the above-mentioned exemplary embodiments and can be implemented in other specific forms without departing from the spirit or basic features of the present invention. Therefore, for every point, the embodiments should be regarded as being exemplary and non-limiting. The scope of the present invention is defined by the appended Claims rather than the above descriptions, and thus intended for include all the variations falling into the meaning and scope of equivalents of the Claims in the present invention. Also, any reference numerals in Claims shall not be regarded as limitations to the Claims concerned. In addition, it is apparent that the term “comprise” is not exclusive of other units or steps, and singular is not exclusive of plural. A plurality of units or means set forth in means Claims may also be implemented by one unit or means by software or hardware. The terms “first”, “second” are intended for represent names without indicating any certain sequence.

What is claimed is:

1. A method for image processing on a user device, the method comprising:
performing image processing based on one or more first template elements selected by a user, Wherein at least one of the one or more first template elements have a counterpart second template element having an equal or higher resolution; and
sending image processing information about the image processing to a corresponding network device, wherein the network device is configured to invoke the second template element.

2. The method according to claim 1, wherein step (a) further comprises:
performing image processing on a first image based on the one or more first template elements selected by a user, wherein at least one of the one or more first template elements has a counterpart second template element having an equal or higher resolution; and
wherein the step (b) further comprises:
sending the image processing information about the first image and the image processing to the corresponding network device, wherein the network device is capable of invoking the second template element.

3. The method according to claim 2, further comprising:
obtaining a low-resolution image corresponding to network access address information for use as the first image.

4. The method according to claim 3, wherein the image processing information includes the network access address information.

5. The method according to claim 2, wherein step (a) further comprises:
reducing resolution of the first image; and
performing the image processing on the resolution reduced first image based on one or more first template elements selected by the user; wherein at least one of the one or more first template elements has a counterpart second template element having an equal or higher resolution.

6. The method according to claim 1, wherein the image processing also comprises at least any one of
setting application format information for an image obtained by the image processing;
setting die-cutting setting information corresponding to a first template element selected by the user for die-cutting setting;
setting varnishing information corresponding to a first template element selected by the user for varnishing preview; or
setting foil-stamping information corresponding to a first template element selected by the user for foil-stamping preview.

7. The method according to claim 1, wherein step (a) also comprises:
displaying the obtained image during the performing of the image processing.

8. A method for image processing on a network device, the method comprising:
A. obtaining image processing information about image processing, wherein the image processing is performed based on one or more first template elements selected by a user, and at least one of the one or more first template elements has a counterpart second template element having an equal or higher resolution; and
B. performing the image processing based on the image processing information by invoking the second template element to obtain a corresponding second image.

9. The method according to claim 8, further comprising:
providing the second image to a corresponding image output device.

10. The method according to claim 8, wherein tine second image also includes at least any one of:
a layer file corresponding o the application format information set by the user;
a layer file corresponding to the die-cutting setting information set by the user:
a layer file corresponding to the varnishing information set by the user;
a layer file corresponding to the foil-stamping information set by the user.

11. The method according to claim 8, wherein step A comprises:
obtaining image processing information about a first image and the image processing, wherein the image processing is performed on the first image based on one or more first template elements selected by a user, and at least one of the one or more first template elements has a counterpart second template element haying an equal or higher resolution; and
wherein the step B further comprises;
performing the image processing on the first image based on the image processing information by invoking the second template element to obtain a corresponding second image.

12. The method according to claim 11, wherein the image processing infix nation includes network access address information corresponding to the first image; and
wherein the step B further comprises:
obtaining an original image corresponding to the network access address information; and
performing the image processing on the original image by invoking the second template element based on the image processing information to obtain the corresponding second image.

13. The method according to claim 8, further comprising:
generating a new corresponding template element based on one or more template elements, and providing the new template element to a corresponding user device.

14. A user device for image processing, comprising:
a first means, configured to perform image processing based on one or more first template elements selected by a user, wherein at least one of the one or more first template elements has a counterpart second template element having an equal or higher resolution; and
a third means, configured to send image processing information about the image processing to the corresponding network device, wherein the network device is capable of invoking the second template element.

15. The user device according to claim 14, wherein the first means is configured to:
perform image processing on a first image based on one or more first template elements selected by a user, wherein at least one of the one or more first template elements has a counterpart second template element having an equal or higher resolution; and
wherein the second means is configured to:
send the image processing information about the first image and the image processing to the corresponding network device, wherein the network device may invoke the second template element.

16. The user device according to claim 15, further comprising:
a fifth means, configured to obtain a low-resolution image corresponding to network access address information for use as the first image.

17. The user device according to claim 16, wherein the image processing information includes the network access address information.

18. The user device according to claim 15, wherein the first means is configured to:
reduce resolution of the first image; and
perform the image processing on the resolution reduced first image based on one or more first template elements selected by the user, wherein at least one of the one or more first template elements has a counterpart second template element having an equal or higher resolution

19. The user device according to claim 14, wherein the image processing also comprises at least any one of:
setting application format information for an image obtained by the image processing;
setting die-cutting setting information corresponding to a first template element selected by the user for die-cutting setting:
setting varnishing information corresponding to a first template element selected by the user for varnishing preview; and
setting foil-stamping information corresponding to a first template element selected by the user for foil-stamping preview.

20. The user device according to claim 14, wherein the first means is also configured to:
display the obtained image during the performing of the image processing.

21. A network device for image processing, comprising:
a second means, configured to obtain image processing information about image processing, wherein the image processing is performed based on one or more first template elements selected by a user, and at least one of the one or more first template elements has a counterpart, second template element having an equal or higher resolution: and
a fourth means, configured to perform the image processing based on the image processing information by invoking the second template element to obtain a corresponding second image.

22. The network device according to claim 21, further comprising:
a sixth means, configured to provide the second image to a corresponding image output device.

21. The network device according to claim 21, wherein the second image also includes at least any one of:
a layer file corresponding to the application format information set by the user;
a layer the corresponding to the die-cutting setting information set by the user;
a layer file corresponding to the varnishing information set by the user;
a layer file corresponding to the foil-stamping information set by the user.

24. The network device according to claim 21, wherein the second means is configured to:
obtain image processing information about a first image and the image processing, wherein the image processing is performed on the first image based on one or more first template elements selected by a user, and at least one of the one or more first template elements has a counterpart second template element haying an equal or higher resolution;
and wherein the fourth means is configured to:
perform the image processing on the first image based on the image processing information by invoking the second template element to obtain a corresponding second image.

25. The network device according to claim 24, wherein the image processing information includes network access address information corresponding to the first image; and
wherein the fourth means is configured to;
obtain an original image corresponding to the network access address information; and
perform the image processing on the original image by invoking the second template element based on the image processing information to obtain the corresponding second image.

26. The network device according to claim 21, further comprising an eighth device, configured to:
generate a new corresponding template element based on one or more template elements, and provide the new template element to a corresponding user device.

27. A system for image processing, comprising:
a user device for image processing of and a network device for image processing:
wherein the user device for image processing comprises a first means, configured to perform image processing based on one or more first template elements selected by a user. wherein at least one of the one or more first template elements has a counterpart second template element having an equal or higher resolution; and a third means, configured to send image processing information about the image processing to the corresponding network device, wherein the network device is capable of invoking the second template element;
wherein network device for image processing comprises a second means, configured to obtain image processing information about image processing, wherein the image processing is performed based on one or more first template elements selected by a user, and at least one of the one or more first template elements has a counterpart second template element having an equal or higher resolution, and a fourth means, configured to perform the image processing based on the image processing information by invoking the second template element to obtain a corresponding second image.
